(19) United States
(12) Patent Application Publication
(10) Pub. No.: US 2009/0022301 A1
(43) Pub. Date: Jan. 22, 2009

(54) MOBILE SERVICES

(75) Inventor: Jayprakash Mudaliar, Hyderabad (IN)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmbH

(21) Appl. No.: 11/832,478

(22) Filed: Aug. 1, 2007

(30) Foreign Application Priority Data
Jul. 19, 2007 (IN) 1388/MUM/2007

(51) Int. Cl. H04M 7/00

(52) U.S. Cl. 379/221.14

(57) ABSTRACT

Systems and methods are disclosed for routing a telephone call to a central system. A plurality of telephone numbers may be associated with a unique identifier. The unique identifier is associated with a data file that is stored on the central system. The data file stores data such as a user's old telephone number and a user's new telephone number. When a request is received from a request initiator to the user's old telephone number, the central system may recognize the old telephone number because it is associated with the unique identifier and may route the request to the new telephone number. A user may register a user device with the unique identifier so that the user receives all requests by callers to the old telephone number and the new telephone number. A user may reject telephone calls and may be permitted to remotely access to the central system.

### FIELD OF THE INVENTION

The invention relates to providing services that route a telephone call. More particularly, the invention relates to routing a telephone call and managing multiple telephone numbers.

### BACKGROUND OF THE INVENTION

Mobile, landline, and VOIP telephone and communication service have become a basic necessity in the modern world. Oftentimes, service providers fiercely compete for customers. Some service providers may offer promotions and sales in an effort to attract new customers to subscribe to their service and to lure existing customers away from a competitor. When a customer changes their service provider, the customer is typically required to change their telephone number. Many customers need or want to provide their telephone number to several entities and/or parties. When the customer's telephone number is changed, the customer must somehow inform the customer's friends, family, business contacts, and the like of the customer's new telephone number, which is difficult and time-consuming.

Oftentimes, customers have multiple telephone or communication accounts with several different service providers. Managing the group of telephone or communication services through different service providers becomes confusing and burdensome. Sometimes, customers fail to manage their account or fail to pay their bill because the management of the service is not convenient and simple. Further, service providers must allocate large budgets to provide each customer with billing and other account information about every account that is associated with a telephone number.

Therefore, systems and methods are needed that provide flexibility to the customer when changing telephone service providers and/or telephone numbers and that permit the customer to manage several telephone accounts with ease and convenience. Further, systems and methods are needed that provide service providers with the ability to reduce the costs and complexities that are associated with managing a customer's account.

### BRIEF SUMMARY OF THE INVENTION

In a first embodiment, a central system may be disclosed for routing a telephone call. The central system may comprise a computing device for containing software, a receiver for receiving data, a server comprising memory for storing computer-executable instructions, and a processor for executing the computer-executable instructions. The software may create a data file that may be associated with the central system. The computer-executable instructions may perform a method that comprises receiving data from the computing device over a computer network, storing the data in the data file associated with the central system, and storing the data file in the memory so that the data file is accessible to the computing device. The computing device, the receiver, and the server may form a central system for routing a telephone call.

In a second embodiment, a method for routing a telephone call may assign a unique identifier to a data file and may establish a first relationship between a first telephone number and the unique identifier. A second relationship may be established between a second telephone number and the unique identifier. A request to connect to the first telephone number may be received and may be associated with the unique identifier based on the first relationship. The request may also be routed to the second telephone number based on the second relationship.

In a third embodiment, a computer-readable medium comprises computer-executable instructions to perform a method. The method may comprise assigning a unique identifier to a data file and establishing a relationship between a first telephone number and the unique identifier. A second relationship may be established between a second telephone number and the unique identifier. A request to connect to the first telephone number may be received and may be associated with the unique identifier based on the first relationship. The request may also be routed to the second telephone number based on the second relationship.

### BRIEF DESCRIPTION OF THE DRAWINGS

The present invention is illustrated by way of example and not limited in the accompanying figures in which like reference numerals indicate similar elements and in which:

FIG. 1 shows a typical prior art workstation and communication connections.

FIG. 2 shows a call routing system in accordance with aspects of the disclosure.

FIG. 3 illustrates a call routing system in accordance with aspects of the disclosure.

FIG. 4 illustrates a method of routing a telephone call in accordance with an embodiment of the disclosure.

### DETAILED DESCRIPTION OF THE INVENTION

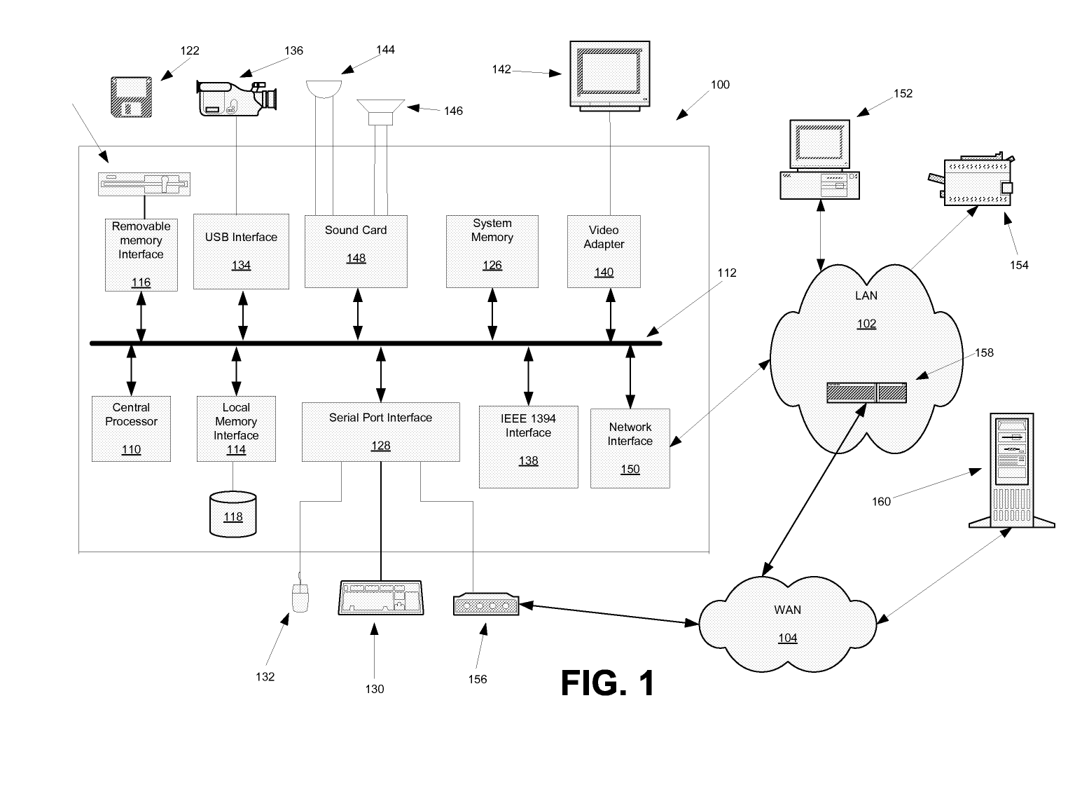

Elements of the present invention may be embodied on a computer system or components of a computer network. FIG. 1 shows an exemplary operating environment in which a computer 100 is connected to a local area network (LAN) 102 and a wide area network (WAN) 104. Computer 100 includes a central processor 110 that controls the overall operation of the computer and a system bus 112 that connects central processor 110 to the components described below. System bus 112 may be implemented with any one of a variety of conventional bus architectures.

Computer 100 may include a variety of interface units and drives for reading and writing data or files. In particular, computer 100 may include a local memory interface 114 and a removable memory interface 116, respectively, that couple a hard disk drive 118 and a removable memory drive 120 to system bus 112. Examples of removable memory drives may include magnetic disk drives and optical disk drives. Hard disks generally include one or more read/write heads that convert bits to magnetic pulses when writing to a computer-readable medium 122 and magnetic pulses to bits when reading data from the computer-readable medium 122. A single hard disk drive 118 and a single removable memory drive 120 are shown for illustration purposes only and with the understanding that computer 100 may include several of such drives. Furthermore, computer 100 may include drives for interfacing with other types of computer readable media such as magneto-optical drives.

Unlike hard disks, system memories, such as system memory 126, generally read and write data electronically and do not include read/write heads. System memory 126 may be implemented with a conventional system memory having a read only memory section that stores a basic input/output system (BIOS) and a random access memory (RAM) that stores other data and files.

A user may interact with computer 100 with a variety of input devices. FIG. 1 shows a serial port interface 128 that couples a keyboard 130 and a pointing device 132 to system bus 112. Pointing device 132 may be implemented with a hard-wired or wireless mouse, track ball, pen device, or similar device.

The computer 100 may include additional interfaces for connecting peripheral devices to the system bus 112. FIG. 1 shows a universal serial bus (USB) interface 134 coupling a video or digital camera 136 to the system bus 112. An IEEE 1394 interface 138 may be used to couple additional devices to the computer 100. Furthermore, the interface 138 may be configured to operate with particular manufacture interfaces such as FireWire developed by Apple Computer and i.Link developed by Sony. Peripheral devices may include touch sensitive screens, game pads, scanners, printers, and other input and output devices and may be coupled to the system bus 112 through parallel ports, game ports, PCI boards or any other interface used to couple peripheral devices to a computer.

The computer 100 also includes a video adapter 140 that couples a display device 142 to the system bus 112. The display device 142 may include a cathode ray tube (CRT), liquid crystal display (LCD), field emission display (FED), plasma display or any other device that produces an image that is viewable by the user. Sound can be recorded and reproduced with a microphone 144 and a speaker 146. A sound card 148 may be used to couple the microphone 144 and the speaker 146 to the system bus 112.

One skilled in the art will appreciate that the device connections shown in FIG. 1 are for illustration purposes only and that several of the peripheral devices could be coupled to the system bus 112 via alternative interfaces. For example, the video camera 136 may be connected to the IEEE 1394 interface 138 and the pointing device 132 could be connected to the USB interface 134.

The computer 100 includes a network interface 150 that couples the system bus 112 to the LAN 102. The LAN 102 may have one or more of the well-known LAN topologies and may use a variety of different protocols, such as Ethernet. The computer 100 may communicate with other computers and devices connected to the LAN 102, such as the computer 152 and the printer 154. Computers and other devices may be connected to the LAN 102 via twisted pair wires, coaxial cable, fiber optics, or other media. Alternatively, radio waves may be used to connect one or more computers or devices to LAN 102.

A wide area network (WAN) 104, such as the Internet, can also be accessed by the computer 100. FIG. 1 shows a modem unit 156 connected to the serial port interface 128 and to the WAN 104. The modem unit 156 may be located internal or external to the computer 100 and may be any type of conventional modem, such as a cable modem or a satellite modem. The LAN 102 may also be used to connect to the WAN 104. FIG. 1 shows a router 158 that may connect the LAN 102 to the WAN 104 in a conventional manner. A server 160 is shown connected to the WAN 104. Numerous additional servers, computers, handheld devices, personal digital assistants, telephones, and other devices may also be connected to the WAN 104.

The operation of the computer 100 and the server 160 may be controlled by computer-executable instructions that may be stored on a computer-readable medium. For example, the computer 100 may include computer-executable instructions for transmitting information to the server 160, receiving information from the server 160 and displaying the received information on display device 142. Furthermore, server 160 may include computer-executable instructions for transmitting hypertext markup language (HTML) or extensible markup language (XML) computer code to the computer 100.

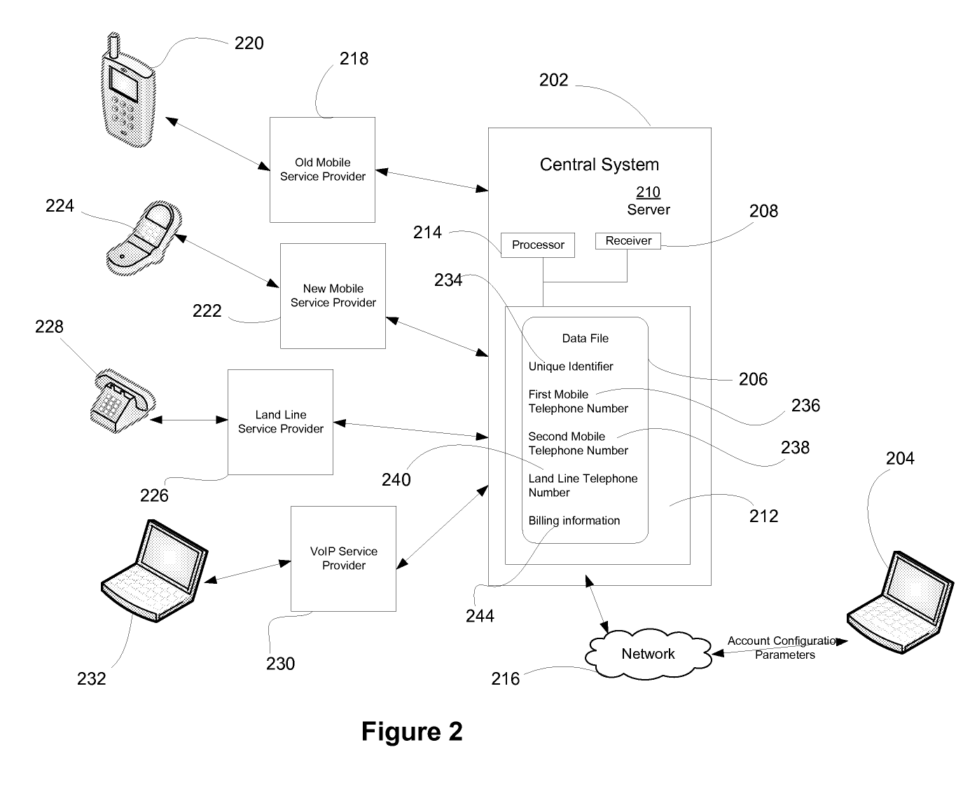

Referring now to FIG. 2, a central system 202 is shown for routing a telephone call. The central system 202 includes a computing device 204 that may contain software for creating a data file 206 that may be associated with the central system 202, a receiver 208 for receiving data, a server 210 comprising memory 212 for storing computer-executable instructions, and a processor 214 for executing the computer-executable instructions. The computer-executable instructions perform a method comprising receiving data from the computing device 204 over a network 216 and storing the data in the data file 206 that is associated with the central system 202. The data file 206 is stored in the memory 212 so that it may be accessible to the computing device 204. The computing device 204, the receiver 208, and the server 210 may form a central system 202 for routing the telephone call.

A unique identifier 234 may be assigned to the data file 206, as shown in FIG. 2. A first relationship may be established between the first telephone number and the unique identifier 234. The first relationship may be any association between the unique identifier 234 and the first telephone number. A request to connect to the first telephone number may be identified as being associated with the data file 206.

A second relationship may also be established between a second telephone number and the unique identifier 234. The second relationship may be any association between the unique identifier 234 and the second telephone number. A request to connect to the second telephone number may be identified as being associated with the data file 206. A request to connect to the first telephone number may be received and associated with the unique identifier 234. The request may be routed to the second telephone number based on the second relationship. The unique identifier may include an internet protocol address or any other identification information.

The central system 202 may be a service that is independent from the mobile service providers, the landline service providers, and the Voice over Internet Protocol (VOIP) service providers, as shown in FIG. 2. The central system 202 may also be an on demand service provider (not shown), as described in detail below. The central system 202 may provide a registration process to a customer or to mobile, landline, and/or VOIP service providers. The customer may choose to register a telephone number or a plurality of telephone numbers with the on demand service provider.

For example, the customer may register a first mobile telephone number 236, a second mobile telephone number 238, and a landline telephone number 240, as illustrated in FIG. 2. The first mobile telephone number 236 may be associated with a new mobile telephone number that may be operated by a customer's new mobile telephone service provider 224, as illustrated in FIG. 2, or may be operated by the customer's old mobile telephone service provider 218. The second mobile telephone number 238 may be associated with an old mobile telephone number that may be operated by the customer's old mobile telephone service provider. The landline telephone number 240 may be a new or an old landline telephone number. A person skilled in the art will appreciate that the first mobile telephone number 236, the second mobile telephone number 238, and the landline telephone number 240 may be operated by any service provider.

The customer may choose to register a telephone number or a plurality of telephone numbers with the central system 202. The registration process may include coupling and/or associating a customer's telephone number and/or account information to the central system 202, associating the user's telephone number with one or a plurality of options, providing billing information relating to the customer's payment options and payment status, and the like.

For example, a customer may have an old mobile service provider 218 that may be associated with a first telephone number 220, a new mobile service provider 222 that may be associated with a second telephone number 224, a landline service provider 226 that may be associated with a landline telephone number 228, and a VOIP service provider 230 that may be associated with a VOIP telephone number 232. The old mobile service provider 218 may be different from the new mobile service provider 222. Each of the mobile service providers 218 and 222, the landline service provider 226, and the VOIP service provider 230 may be coupled to the central system 202 and may access and/or manage the customer's account. Further, a customer may be permitted to access the central system 202 to manage and manipulate each of the telephone numbers 220, 224, 228, and 232 that are associated with the central system 202.

The central system 202 may include an on demand service provider. The on demand service provider may provide access to the central system by a customer as requested. The on demand service provider may provide a central system 202 that receives a request from a customer for an on demand service. The central system 202 may be stored on a server or any other accessible system. The central system 202 may communicate with any wired or wireless device that may be analog or digital devices. Further, the central system may access any network including, but not limited to, a public switched telephone network (PSTN), a plain old telephone system (POTS), a computer network, and a cellular network.

The on demand service provider may provide the customer with one or more options to customize the requests to the telephone numbers that are associated with the central system 202. The customer may access the options via a website on a computer network or group of computer networks, such as the Internet or an intranet, or may access the options through a call center. A call center may provide the customer with the ability to make a request from a telephone number to access and manage the central system 202. One of ordinary skill will appreciate that the customer may access the options for the central system in any desirable manner, including a landline telephone, mobile telephone, and/or VOIP telephone.

For example, the on demand service provider may provide the customer with the ability to automatically or manually send a message in response to a request to an initiator of the request. The message may include information that informs the initiator of the request that the telephone number is not the customer's current telephone number. The message may also include the customer's new telephone number and/or any other desirable message.

The on demand service provider may also provide the customer with a contact list comprising one or more contacts. The contact list may include information such as a contact's mobile telephone number, landline telephone number, electronic mail address, business address, home address, and the like. The on demand service provider may provide the customer with access to the contact list by coupling the contact list to the central system 202. Additionally, the customer may automatically or manually send a message to all or a portion of the contacts that are included in the contact list.

The on demand service provider may provide the customer with call forwarding services through the central system 202. Call forwarding services may include routing a request associated with a first telephone number 236 to an alternate telephone number (not shown). The customer may select a portion or all of the telephone numbers that may be registered, associated, and/or coupled to the central system 202 for routing to the alternate telephone number. The customer may choose to temporarily or permanently route telephone calls to the alternate telephone number. The customer may also choose to forward a telephone call to an alternate telephone number that is or is not associated with the central system 202.

The on demand service provider may also provide the customer with the option to route all requests to a single user device. For example, the customer may register a first mobile telephone number 236, a second mobile telephone number 238, a landline telephone number 240, and a VOIP telephone number (not shown) with the central system 202. The customer may select the option that all requests that may be received by the first mobile telephone number 236, a second mobile telephone number 238, a landline telephone number 240, and a VOIP telephone number may be routed to the first mobile telephone number 236.

The customer may place restrictions on the telephone number to which all or any portion of the requests may be routed. As described above, the customer may have a first mobile telephone number 236, a second mobile telephone number 238, a landline telephone number 240, and a VOIP telephone number. The first mobile telephone number 236 may be associated with the customer's personal telephone number and the second mobile telephone number 238 may be associated with the customer's business telephone number. The customer may choose to route all of the requests that are received on the customer's personal telephone number during business hours to the business telephone number. The customer may also choose to route all of the requests that are received on the business telephone number after business hours to the personal telephone number. The customer may choose to route the requests to a telephone number in any desirable manner.

The on demand service provider may also provide the customer with the option of managing a request that is sent from a telephone number that may be associated with the central system 202. The customer may have a first mobile telephone number 236, a second mobile telephone number 238, a landline telephone number 240, and a VOIP telephone number, as described in detail above. For example, the customer may choose to permit a second user to send requests from a first mobile telephone number 236. The customer may restrict the type of requests that may be made by the second user from the first mobile telephone number 236. For example, the second user may be restricted to sending a request to a local telephone number or may be required to enter an access code to place a long distance or international request.

The customer may also select the option of automatically or manually rejecting requests from an undesirable initiator. The customer may select one or a group of telephone numbers from whom the central system 202 may automatically reject a request. Further, the customer may manually reject a request by an unknown or undesirable initiator after the request is received. The option to reject a request may be applied to any or all of the telephone numbers that may be associated with the central system 202.

The on demand service provider may provide the customer with the option of accessing the billing information 244 relating to all of the customer's telephone service providers. The billing information 244 may provide the customer with the ability to submit one payment that may be applied to all of the telephone numbers that are associated with the central system 202.

The on demand service provider may also provide the customer with the option to identify the customer's location or status. The customer's location may be the city, state, country, time zone, or the like of the customer's location. The on demand service provider may provide a message to the initiator that identifies the customer's location.

The customer's status may be available, unavailable, in meeting, sleeping, shopping, or any other desirable status. The customer's status may be the same for a portion or all of the telephone numbers that are associated with the central system 202 or may be different for each of the telephone numbers that are associated with the central system 202. The customer's status may be sent to the initiator in response to a request and may be restricted to one or a group of initiators that have been identified by the customer.

For example, a customer may arrive at work at 8 a.m., have a meeting from 3 p.m. until 4 p.m., leave work at 6 p.m., and sleep from 11 p.m. until 6 a.m. The customer may identify the time between 8 a.m. and 3 p.m. as having an available status, the time between 3 p.m. and 4 p.m. as having an in meeting status, the time between 6 p.m. and 11 p.m. as having an unavailable status, and the time between 11 p.m. and 6 a.m. with a sleeping status. An initiator that places a request to the customer at 10 a.m. may be notified that the customer has an available status, a call initiator that places a request to the customer at 3:30 p.m. may be notified that the customer has an in meeting status, and the like. One skilled in the art will recognize that the call initiator will be notified of the customer's status based on the time at which the request is received.

In the previous example, the initiator may be notified of the customer's status by a unique message such as a ring tone, text message, automatic routing to the customer's voicemail, and/or any other unique message. The customer may also choose to be alerted of a request that may be received during any status. For example, if the customer identifies a status of unavailable between 4 p.m. and 7 p.m., any initiator may be notified of the customer's unavailable status. The customer may also identify one or more initiators that may be permitted to send a request to the customer regardless of the customer's status. For example, the customer may permit unrestricted requests that may be initiated by the customer's spouse, children, or boss.

In another example, the customer may be alerted of an initiator's request when the request includes desirable criteria. As described above, the customer may choose to receive alerts of a request from an initiator regardless of the customer's status. The customer may also permit an initiator to identify a request as urgent. When an urgent request is received during an unavailable status, in meeting sleep, sleeping status, or the like, the initiator may be sent a request to hold for a period of time or perform an action that indicates that the request is urgent. For example, an initiator may identify a request as being urgent. The initiator may be sent a request to hold for 30 seconds. During the 30 seconds, the customer may not be alerted of the request. After the 30 seconds expires, the initiator may identify the request as urgent, and the customer may be alerted of the urgent request. Further, the customer may select a unique alert for urgent requests such as a unique ring tone or the like.

The customer may identify the type of alert that the customer may receive when a request is received. For example, when a customer identifies an available status, the customer may be alerted by a ring tone or other auditory signal. When a customer identifies an in meeting or unavailable status, the customer may be alerted of a request by a single beep, vibration of the customer's user device, visual signals, and/or any other discrete means of alert. The customer may select that the central system 202 provide no alert when the customer identifies an unavailable or sleeping status. A person having ordinary skill in the art will appreciate that the customer may select any desirable alert.

The customer may be alerted of an unanswered request at the customer's discretion. The customer may choose to route an unanswered request to a voicemail service or other type of answering service. The customer may also send a message to an initiator in response to an unanswered request, as described above. The message may be a message informing the initiator that the customer is not available or any other desirable message. The customer may choose to store the information relating to the unanswered requests and the customer may review the information at another time. For example, information relating to an unanswered call may be stored as a missed call or any other desirable identification.

As discussed in detail above, the computing device 204 may contain software for creating a data file 206. Software may be stored within memory 212 and may provide instructions to the processor 214 for enabling the computing device 204 to perform various functions. For example, the memory 212 may store software, such as an operating system, application programs, and an associated data file 206. Alternatively, some or all of the computer executable instructions for computing device 204 may be embodied in hardware or firmware (not shown). As described in detail below, the data file 206 may provide centralized storage of a unique identifier 234, a first mobile telephone number 236, a second mobile telephone number 238, a landline telephone number 240, and billing information 242. A person having ordinary skill in the art will appreciate that the data file 206 may include any desirable information related to the customer.

The unique identifier 234 may be any identifier that at least partially identifies the data file 206. For example, an internet protocol address (IP address) may be assigned to the data file 206 and may identify the data file's location on the server 210. In another example, a unique identifier 234 may be a randomly or deliberately assigned a number that is associated with the data file 206. Several data files may be stored in the memory 212 and a different unique identifier 234 may be assigned to each data file. A person having ordinary skill in the art will appreciate that the unique identifier 234 may be any identifier that may at least partially identify a data file 206.

The data file 206 may also include information relating to a plurality of telephone numbers that includes a mobile telephone number coupled to a cellular network that may be provided by a mobile service provider, a landline telephone number coupled to a public switched telephone network that may be provided by a landline service provider, and a VOIP telephone number coupled to a computer network that may be provided by a VOIP service provider. The mobile service provider, the landline service provider, and the VOIP service provider may communicate with the central system 202 and may access and manage a data file 206. For example, the mobile service provider, the landline service provider, and the VOIP service provider may provide billing information to the central system 202. Additionally, the customer may also communicate with the central system 202 and access and manage the data file 206 in any desirable manner.

A first mobile telephone number 236 and a second mobile telephone number 238 may be assigned to a user device 220 that communicates over a cellular network. The cellular network may be provided and maintained by an old mobile service provider 218. A mobile service provider maintains a series of cell sites or base stations that transmit radio signals of varying frequencies. Each cell site or base station may provide its own transmitter and its own transmission radius. The transmission radius is defined by a space within which the radio signal from the cell site or base station may reach.

The transmitter and transmission radius that is associated with one cell site or base station may be distinguishable from the transmitter and transmission radius that is associated with other cell sites or base stations. A user device may communicate through the cellular network by connecting to a cell site or base station within its transmission radius. The user device may manually or automatically connect to another cell site or base station when the user device transcends from the transmission radius of one cell site or one base station to the transmission radius of another cell site or base station. One of ordinary skill in the art will appreciate that the transmission radius of one cell site or base station may overlap with the transmission radius or radii of one or more additional cell site or base stations.

A landline telephone number 240 may be assigned to a user device 228 that communicates over a solid medium. For example, a landline telephone user device may be coupled to the plain old telephone system (POTS) over a physical cable or may be coupled to the PSTN over metal wire or optical fiber. The PSTN may be either digital or analog and may include wired or wireless user devices. A landline telephone user device 228 may communicate with other user devices at least partially over the PSTN.

A VOIP telephone number 242 may be assigned to a user device 232 that communicates over a public packet network. For example, a VOIP telephone user device 232 may be coupled to a computer network such as the Internet or an intranet. The VOIP telephone user device 232 may be coupled to a public or private computer network and may communicate with other user devices at least partially over the public or private network.

A person having ordinary skill in the art will appreciate that the user devices that are coupled to a cellular network, a landline, a public packet network, and the like may communicate with one another through a gateway (not shown). A gateway may provide a link between computers or networks. The gateway may also control access between computers or between networks.

A request may be a telephone call that originates from a PSTN, a cellular network, a computer network, and the like. For example, a request to a cellular telephone number that is associated with a cellular network may originate from the PSTN. The request may be routed from the PSTN through a gateway between the PSTN and the cellular network. The request may be received on the cellular network and may be routed to the cellular telephone number. Referring again to FIG. 2, the data file 206 may include information relating to billing information 244. Billing information 244 may include information relating to a customer's payment information and other account information. The billing information 244 may also provide a status report on the customer's account and the balance that may be due on a customer's account. The billing information 244 may generate a statement reflecting the customer's account information that is stored in the data file 206. The statement may be sent electronically to the customer's user device. The billing information 244 may also provide the customer with the ability to enter and store data relating to the customer's account in the data file 206. The billing information 244 may also include restrictions on a customer's account such as whether the customer is permitted to place and receive an international request and credit limit restrictions that restrict and/or terminate the customer's account if a customer fails to pay the bill.

Further, the data file 206 may include information relating to a phone book (not shown). The phone book may include information about a customer's contacts and may be organized in any desirable fashion. The customer's contact information may be organized by entity and may include such contact information as an entity's name, address, telephone number, electronic mail address, website address, and the like. The customer may be provided access to the phone book via a telephone number that may be associated or registered with the central system 202. A person having ordinary skill in the art will appreciate that the data file may include any information relating to the central system 202.

The central system 202 may be configured with a customer's account. The customer's account may be associated with one or more telephone numbers, including but not limited to, a mobile telephone number, a landline telephone number, and a VOIP telephone number, as described above. As described above in detail, a unique identifier 234 may be assigned to the central system 202. A first mobile telephone number 236 may be a new mobile telephone number and the second mobile telephone number 238 may be an old mobile telephone number that may be associated with the central system 202.

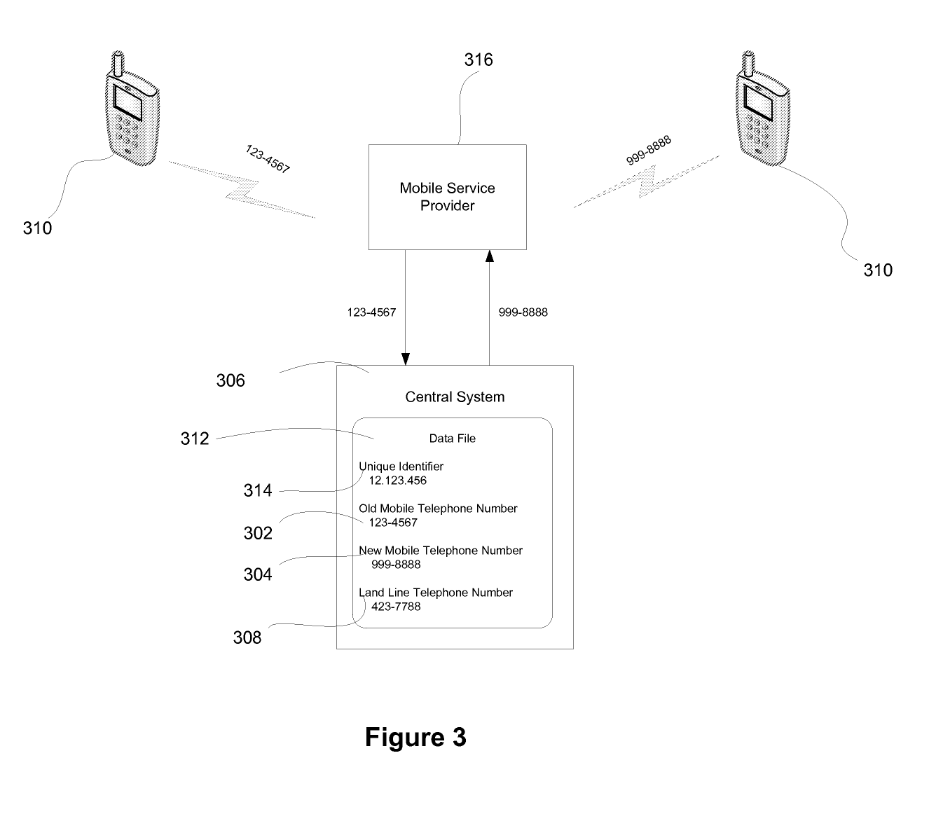

As illustrated in FIG. 3, a central system 306 may redirect a request to an old mobile telephone number 302 to a new mobile telephone number 304 through the central system 306. A customer may receive the request to the old mobile telephone number 302 on a user device 310 that may be coupled to the central system 306. A request to the landline telephone number 308 may also be routed to the user device 310 that may be coupled to the central system 306. The customer may designate that any portion of the requests that are made to the old mobile telephone number 302, the new mobile telephone number 304, and the landline telephone number 308 be routed through the central system 306 and to the user device 310. One of skill in the art will appreciate that the customer may redirect requests that are received by a plurality of old telephone numbers to the new mobile telephone number 304 or other desirable telephone number.

Further, a customer may register an old telephone number and a new telephone number with the central system 306 in any desirable manner. A customer may establish one or more options that identify the telephone number to which a request may be directed. For example, a customer may establish an option that all requests to an old mobile telephone number 302 may be directed to a new mobile telephone number 304. The customer may also establish an option that an alert may be sent to the initiator of the request in response to a request from the old mobile telephone number 302. The alert may include information that discloses that the request is being directed from the old mobile telephone number 302 to the new mobile telephone number 304 and may also identify the new mobile telephone number 304.

Additionally, the alert may include information relating to the customer's status. The customer may be available to receive a request when the customer establishes an available status with the central system 306. The customer may choose to permanently establish an available status or to establish an available status for a fixed period of time. The customer may be unavailable to receive a request when the customer establishes an unavailable status with the central system 306. The customer may also be informed of the identity of the initiator. The customer may select whether the customer has available or unavailable status with respect to the initiator. The customer may also reject a request from an initiator either permanently, temporarily, or on a selective basis.

Additionally, the customer may establish an option that routes a request to a messaging system. The messaging system may include voicemail or other answering service. The messaging system may also include a message that informs the initiator that the request is being routed to a messaging system.

The customer may establish an option that routes a request that is made to a first telephone number to a second telephone number that is different from the first telephone number. Further, the user may establish an option that temporarily or permanently routes a request from a first telephone number to a second telephone number. However, one of ordinary skill in the art will appreciate that a customer may establish any desirable routing options.

The central system 306 may be stored on the server and may be accessible through a webpage on the Internet or an intranet. The webpage may have security, such as a username and password that must be entered before the customer may obtain access to the central system 306. Messages to and from the webpage may also be encrypted. A person having ordinary skill in the art will appreciate that any form of security may be implemented on the central system 306 and/or data file 312.

Additionally, a customer may register one or more telephone numbers with the central system 306. The customer may be required to identify a code such as a username and/or password before registering a telephone number. Further, the customer may access the central system 306 and/or data file 312 through a website over the Internet or an intranet and through a request such as a telephone call.

Referring back to FIG. 2, a computing device 204 may be coupled to a computer network 216 and may contain software for creating a data file 206. The computing device 204 may be any electronic device that receives and processes information according to a set of instructions. The computing device 204 may have a user interface that is capable of producing a visual display. The telephone call may be routed by utilizing the software that is executed by the computing device 204. One of skill in the art will appreciate that more than one computing device 204 may be used.

The computing device 204 may be any electronic device that receives and processes information according to a set of instructions in the software. The software may be a set of detailed computer-executable instructions that a computing device 204 may execute. The software provides the computing device 204 with the ability to create a data file 206 and route a telephone call based on data stored within the data file 206.

Referring again to FIG. 2, a receiver 208 may be included in the system for identifying a compromised account. The receiver 208 receives data that may be executed by the processor 214 or received directly into the data file 206. Ultimately, a portion of the data (or the processed data) may be received into the data file 206. One of ordinary skill in the art will appreciate that the data may contain any information that a central system 202 may need to route a telephone call.

The receiver 208 may be any device that is capable of receiving an electrical signal. Moreover, the receiver 208 may be a device that is also capable of transmitting the electrical signal from one location to another. For example, a receiver 208 may be input/output (I/O) hardware in a computing device 204 or server 210 that may send and receive data and store the data in a data file 206 or send the data to a processor 214 for processing.

For example, data may be received by the receiver 208, and may be sent to a server 210. In FIG. 2, a receiver 208 is shown as being included within the server 210. The server 210 may be any shared computer that is operatively coupled to a network 216 and that acts as a repository and distributor of data. The server 210 may be any shared computing device. The server 210 also may be a fast and robust computing device 210 that acts to organize and regulate data that is being transmitted to the network 216. The server 210 may be accessible as a web server over the Internet or an intranet. Furthermore, the server 210 may be embodied as a server farm comprising multiple computers that provide a scaleable and/or secure architecture. One of ordinary skill in the art will appreciate these and other aspects of the server 210 after review of the entire disclosure herein.

The server 210 may include memory 212 for storing computer-executable instructions and a processor 214 for executing computer-executable instructions. The computer-executable instructions may be data in the form of program source code that is capable of modifying the data file 206. The computer-executable instructions may be a series or sequence of instructions for a computing device that may be in the form of a programming language such as C++, Java, SQL, or the like. A person of ordinary skill in the art will appreciate that various computer programming languages may be used to create the computer-executable instructions, and the invention is not limited to the computer programming languages disclosed herein.

Memory 212 may be a portion of the server 210 and may store data or other instructions for later use. The memory 212 may be retained or lost when power is lost to the system. The processor 214 may be capable of executing the computer-executable instructions. The computer-executable instructions may be executed by the processor 214 after they have been stored in the memory 212. The processor 214 may be a centralized element within a computing system that is capable of performing computations. For example, the processor 214 may perform the computations that are described in the computer-executable instructions and then execute the computer-executable instructions. The computer-executable instructions may include data describing changes to the data file 206 that were made by a user or computing device 204 over the network 216.

Referring now to FIG. 3, the data that is stored in a data file 312 may include data related to a unique identifier 314, an old mobile telephone number 302, a new mobile telephone number 304, and a landline telephone number 308, as described in detail above. For example, the data file 312 may be stored on a central system 306. The central system 306 may receive a request to communicate with the old mobile telephone number 302 at a mobile service provider 316. The mobile service provider 316 may direct the request to a central system 306, where the central system 306 may be associated with the unique identifier 314.

The new mobile telephone number 304 may also be associated with the central system 306. The central system 306 may receive a request to the old mobile telephone number 302 and redirect it to the new mobile telephone number 304. The central system 306 may also redirect the request to the landline telephone number 308 or any other telephone number that may be associated with the central system 306.

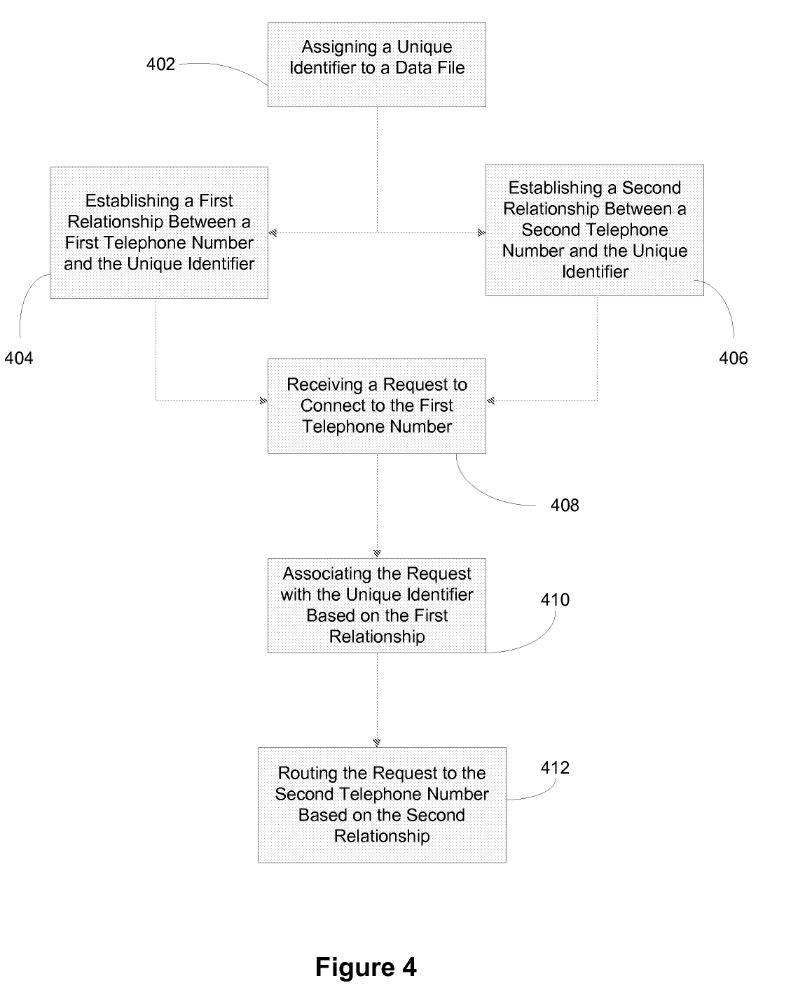

In another embodiment, a method of routing a telephone call is illustrated in FIG. 4. A unique identifier may be assigned to a data file at step 402 and a first relationship may be established between a first telephone number and the unique identifier at step 404. A second relationship may be established between a second telephone number and the unique identifier at step 406. A request to connect to the first telephone number may be received at step 408. In step 410, the request may be associated with the unique identifier based on the first relationship. The request may be routed to the second telephone number based on the second relationship at step 412.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A method of routing a telephone call, comprising:
assigning a unique identifier to a data file;
establishing a first relationship between a first telephone number and the unique identifier;
establishing a second relationship between a second telephone number and the unique identifier;
receiving a request to connect to the first telephone number;
associating the request with the unique identifier based on the first relationship; and
routing the request to the second telephone number based on the second relationship.

2. The method of claim 1, further comprising providing an on demand service.

3. The method of claim 1, where the unique identifier includes an internet protocol address.

4. The method of claim 1, where the data file is accessible through a webpage on the Internet.

5. The method of claim 1, where the request is a telephone call originating from a public switched telephone network.

6. The method of claim 1, where the request is a telephone call originating from a cellular network.

7. The method of claim 1, where the request is a telephone call originating from a computer network.

8. The method of claim 1, further comprising registering the first telephone number.

9. The method of claim 1, further comprising selecting an option that is applied to the request.

10. The method of claim 9, where the option is a status.

11. The method of claim 1, further comprising rejecting the request.

12. A central system for routing a telephone call, comprising:
a computing device for executing software for creating a data file associated with the central system;
a receiver for receiving data;
a server comprising memory for storing computer-executable instructions; and
a processor for executing the computer-executable instructions to perform a method, comprising:
receiving data from the computing device over a computer network;
storing the data in the data file associated with the central system;
storing the data file so that the data file is accessible to the computing device;
wherein the computing device, receiver, and server form a central system for routing a telephone call.

13. The system of claim 12, where the computer-executable instructions further comprise selecting an option that is applied to the request.

14. The system of claim 12, where the data includes information relating a first telephone number and a second telephone number.

15. The system of claim 14, where the first telephone number is an old telephone number and the second telephone number is a new telephone number.

16. The system of claim 12, where the data includes an internet protocol address.

17. The system of claim 12, where the central system is operated by an on demand service provider.

18. The system of claim 12, further comprising a user device for receiving a telephone call.

19. The system of claim 16, where the central system is accessible through a webpage on the Internet.

20. A computer-readable medium comprising computer-executable instructions to perform a method, comprising:
assigning a unique identifier to a data file;
establishing a first relationship between a first telephone number and the unique identifier;
establishing a second relationship between a second telephone number and the unique identifier;
receiving a request to connect to the first telephone number;
associating the request with the unique identifier based on the first relationship; and
routing the request to the second telephone number based on the second relationship.
